(19) United States
(12) Patent Application Publication
(10) Pub. No.: US 2025/0133067 A1
(43) Pub. Date: Apr. 24, 2025

(54) Product Authentication and Theft Detection System and Method using Encrypted Radio Frequency Devices

(71) Applicant: Shant Lokmanian, Sun Valley, CA (US)

(72) Inventor: Shant Lokmanian, Sun Valley, CA (US)

(21) Appl. No.: 18/493,328

(22) Filed: Oct. 24, 2023

(51) Int. Cl. H04L 9/40; G06Q 30/018

(52) U.S. Cl. CPC H04L 63/0435; G06Q 30/0185

(57) ABSTRACT

A system and method for product authentication and theft detection using encrypted NFC tags is disclosed. Each NFC tag is encoded with a unique identifier, counter algorithm, and encryption key. A scanning device scans the NFC tags and receives an encrypted message generated using the unique ID, counter value, and encryption key. A verification server stores encryption keys and associated decryption keys, maintains a database associating unique IDs with products, receives encrypted messages, decrypts them with the decryption keys, and verifies authenticity and ownership. In some aspects, an owner can register a product to their profile by scanning the tag. Ownership transfers are updated by changing the association. By maintaining unique IDs of store inventory and comparing to point of sale data, missing products are determined as stolen. When a stolen tag is scanned, a warning is returned.

### FIELD OF INVENTION

The present invention relates generally to systems and methods for authenticating products and detecting theft through the use of encrypted near-field communication (NFC) tags encoded with unique identifiers and encryption keys. The invention further pertains to tracking of product ownership and identifying lost or stolen items based on scans of NFC tags compared against point of sale and inventory records. The field of invention aims to enhance product security, combat counterfeiting, and reduce retail theft through multi-layered verification protocols.

### BACKGROUND OF THE INVENTION

Product counterfeiting and theft have persisted as major global challenges inflicting substantial economic and social harms. Despite attempts to combat these issues through various anti-counterfeiting and anti-theft technologies over the years, systemic vulnerabilities remain exploited by nefarious actors across production and retail environments.

Legacy solutions for authenticating genuine products and preventing theft such as standard barcodes, RFID tags, holograms, and tamper-proof labels have proven insufficient. These methods offer limited tracking abilities and security features which are routinely forged or removed from products. Consequently, manufacturers continue losing billions of dollars annually to knockoffs while consumers are exposed to dangerous frauds.

In response, more advanced systems have emerged aiming to leverage encrypted communications, mobile capabilities, and backend verification to bolster protections. For example, prior art includes proposals to integrate scannable identification into goods which interact with databases to confirm legitimacy. Other prior art describes mutual authentication regimes between networked tags and scanning devices paired with remote server validation.

However, existing protocols have not yet provided an adequate comprehensive solution spanning robust anti-counterfeiting technology, thorough monitoring abilities, and lost item detection. There exist further opportunities to synergize encrypted identification methods, owner tracking functionalities, inventory monitoring, and point of sale systems. The core technological components to actualize such a system are readily available. The remaining challenge is seamless integration and implementation on a mass scale.

It is apparent that despite earlier attempts to curb counterfeiting and theft, these criminal activities remain rampant to the detriment of producers, retailers, and consumers. Prior art methods have fallen short in providing a holistic solution. This points to the need and opportunity for an integrated system overcoming the vulnerabilities of previous technology. Development of such a system would yield substantial economic and social value by protecting the integrity and security of global supply chains. The commercial prospects are significant, and the societal impacts include increased safety, reduced losses, and greater transparency.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

In some embodiments thereof, the present invention relates to systems, methods and computer program products for authenticating products and detecting theft using near-field communication (NFC) tags. Each NFC tag is encoded with a unique identifier, counter algorithm, and encryption key. When scanned by a mobile device, the NFC tag generates a secure encrypted message utilizing its unique identifier, current counter value, and encryption key encoded on the tag. This encrypted message is transmitted to a verification server which stores a database matching the unique identifiers to associated products. The server also maintains the encryption keys and related decryption keys in order to decrypt the incoming messages. By decrypting with the proper key and analyzing the unique identifier, the server can authenticate the scanned product.

In one alternative implementation, the NFC tags may all utilize a common base encryption key generated directly by the server rather than unique derived keys. This base encryption key is programmed identically onto all tag microchips by the programming device. While less secure than unique keys, this allows the server to encrypt and decrypt all tag messages using just the one key. The server simply indexes received encrypted messages using the tags' UIDs without needing to maintain a mapping of derived keys.

In another variation, the server may be able to compute or rediscover the original base encryption key from any given tag's derived key using the reverse of the salting derivation process. Since the server knows the random salt value (such as the tag identifier) and final derived key, it can work backwards to find the initial base key.

In some aspects, the system maintains profiles of owners linked to specific product unique identifiers. A consumer can register a purchased product to their profile by scanning the NFC tag and submitting ownership information. The system allows transferring of products to new owners by changing the owner profiles connected to the identifiers. By keeping track of products registered to owners, the system facilitates recovery of lost or stolen items.

In another aspect, the system can interface with retail infrastructure to monitor products within stores and flag potential thefts. By maintaining a database of NFC tag unique identifiers attached to inventory at a store location, the server can track which products are present. This is supplemented with point of sale data showing items successfully sold. By comparing inventory to sales records, the system can determine products that have left the premises without being purchased. When items are removed from the store floor without being sold, the corresponding unique identifiers are registered as stolen. If these missing products are later scanned, warnings will be returned to the scanning device indicating their stolen status.

In multiple aspects, synergistic integration of encrypted NFC tag communications, owner tracking capabilities, and interlinking with retail systems provides advanced anti-counterfeiting and anti-theft functionality. The encryption mechanisms and unique messaging prevent duplication of static identifiers found on conventional tags. Registration of ownership enables consumers to protect purchased products. Identifying items missing from inventories but not sold allows retailers to monitor potential thefts. Together these features offer a robust solution for manufacturers, retailers, and consumers to combat counterfeits and retail crime.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an NFC tag being encoded with encryption keys, counter program and unique identifier.

FIG. 2 illustrates the transmission of an encrypted message from an encoded NFC tag to a reader device via an electromagnetic field.

FIG. 3 illustrates a programming device coupled to a server generating encryption keys, and encoding these encryption keys on NFC tags.

FIG. 4 illustrates a reader receiving an encrypted message from an NFC tag, and transmitting the message to receive a decrypted message from a server.

FIGS. 5A, 5B and 5C illustrates a variety of authentic products embedded with encoded NFC tags.

FIG. 6 illustrates authentication of the authenticity of a product with an encoded NFC tag.

FIG. 7 illustrates a monitoring RFID tower reading tags embedded to products at a store location connected to a remote authentication server.

FIG. 8 illustrates detection of removal of item from a store by an RFID tower.

FIG. 9 illustrates verification of a product embedded with encoded NFC tag.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

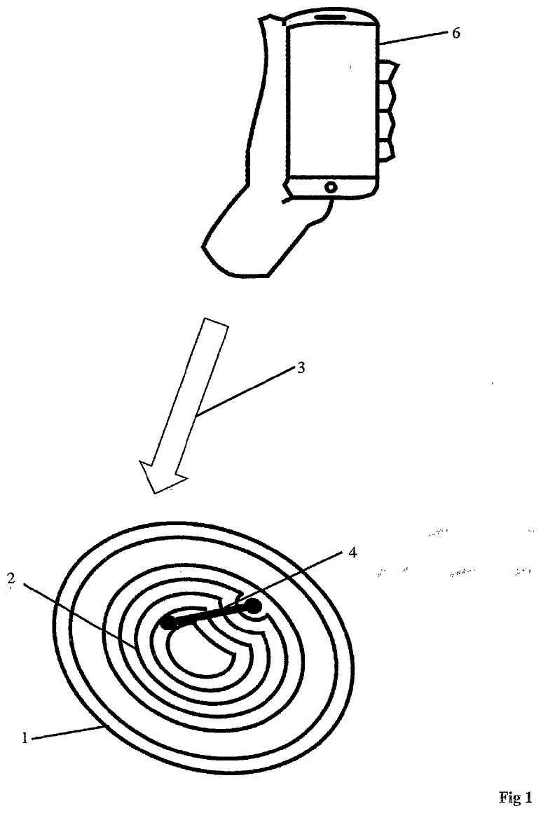

In the illustrated embodiment of FIG. 1, it is illustrated an NFC tag 1 being encoded with encoding data 3 comprising encryption keys, counter program and unique identifier. The NFC tag 1 includes an internal chip 4 and circuitry 2 which may comprise an antenna for wireless communication. The NFC tag 1 draws power from the electromagnetic field generated by a nearby scanning device. A programming device 6 is configured to securely program the internal chip 4 of the NFC tag 1 during or after the manufacturing process.

The programming device 6 encodes the chip 4 with one or more unique encryption keys usable only by that specific tag. These encryption keys are generated by a verification server and shared with the programming device 6. Additionally, the programming device 6 encodes a unique identifier (UID) guaranteed to be unique among all tags. The UID allows the tag to be distinguished when scanned. Further, the programming device 6 implements a counter program which maintains a running count of the number of scans performed on the tag.

In alternative implementations, different wireless communication technologies may replace NFC for the tag including Bluetooth Low Energy (BLE), standard RFID, Wi-Fi, and various other wireless protocols. The tag may also incorporate additional sensors such as GPS for location tracking or a barcode/QR code as a secondary identification method. Regardless of the specific wireless technology, the tag will contain a customized chip encoded with unique encryption keys, a unique identifier, and a scan counter.

When powered by a reader, the encoded chip 4 communicates via the antenna circuitry 2. The chip 4 increments the scan counter, generates an encrypted message containing the UID and counter value using the on-chip encryption keys, and transmits the message. The scanning device relays this information to a verification server which authenticates the tag and associated product by decrypting the message and analyzing the contents.

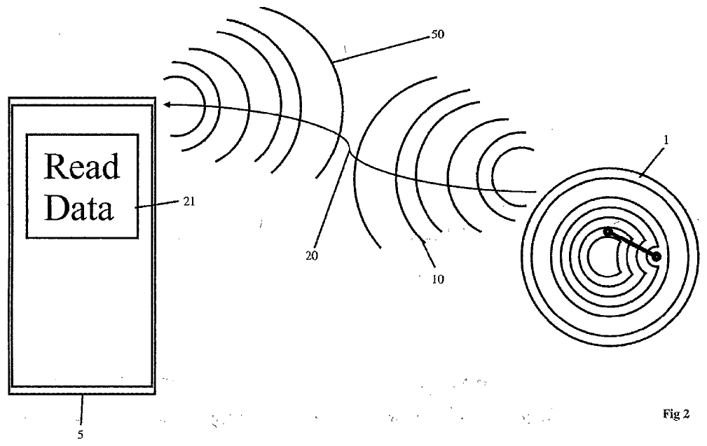

The exemplary embodiment according FIG. 2 illustrates the transmission of an encrypted message 20 from an encoded NFC tag 1 to a reader device 5 via an electromagnetic field. The reader device 5 generates an electromagnetic field 50 to power the NFC tag 1. This electromagnetic field 50 allows the passive NFC tag 1 to operate and communicate without needing an internal power source.

When powered, the microchip inside the NFC tag 1 increments the scan counter, generates an encrypted message 20 by retrieving the unique identifier, current counter value, and utilizing the on-chip encryption key(s). This encrypted message 20 contains the tag's unique identifier and current scan count in an encrypted form readable only by the verification server holding the associated decryption keys.

The NFC tag 1 then modulates and transmits the encrypted message 20 by varying electrical load on the antenna circuitry. The variations are detected by the reader 5 via changes in the electromagnetic field 50. In this manner, the encrypted message 20 is transmitted completely wirelessly from the tag 1 to the nearby reader device 5 powered by the reader's electromagnetic field generation.

The reader device 5 receives the encrypted wireless signal and relays the encrypted message 20 to the remote verification server, such as via the Internet. The verification server then decrypts the message, verifies the unique identifier, updates the scan count, and returns authentication results or warnings as applicable based on the business logic processed.

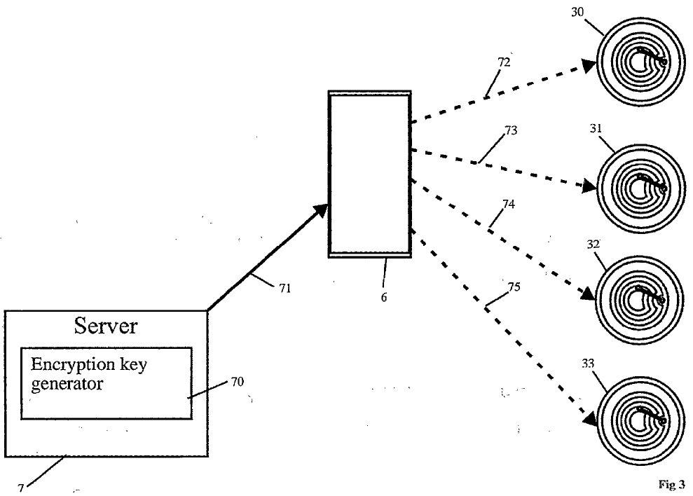

Reference is now made to FIG. 3, which illustrates a programming device 6 connected to a server 7 that generates encryption keys and encodes them onto NFC tags according to an embodiment. The server 7 runs an encryption key generation program 70 that creates unique encryption and decryption key pairs. The encryption keys are securely transmitted to the programming device 6 in process 71.

As shown in the figure, there are NFC tags 30, 31, 32 and 33 which are to be encoded by the programming device 6. For tag 30, the programming device encodes encryption key(s) 72 generated by the server 7. Similarly, tags 31, 32, and 33 are encoded with encryption keys 73, 74, and 75 respectively, which are unique keys generated on the server 7 for each tag.

Additionally, the programming device 6 may encode a unique identifier (UID) on each tag that allows the tag to be distinguished when scanned. The UIDs and associated encryption keys encoded on each tag are stored in a database on the server 7 for later reference. This allows the verification server to retrieve the appropriate decryption key to decrypt messages from a specific tag using its UID as an index.

The one-to-one mapping between UIDs, encryption keys, and decryption keys enhances security. Encryption keys are only shared with the programming device and never transmitted, and the programming device has no access to the decryption keys. Each tag only ever possesses its own UID and encryption key(s) programmed onto its microchip. This system prevents a single compromised tag from affecting the integrity of the overall product authentication scheme.

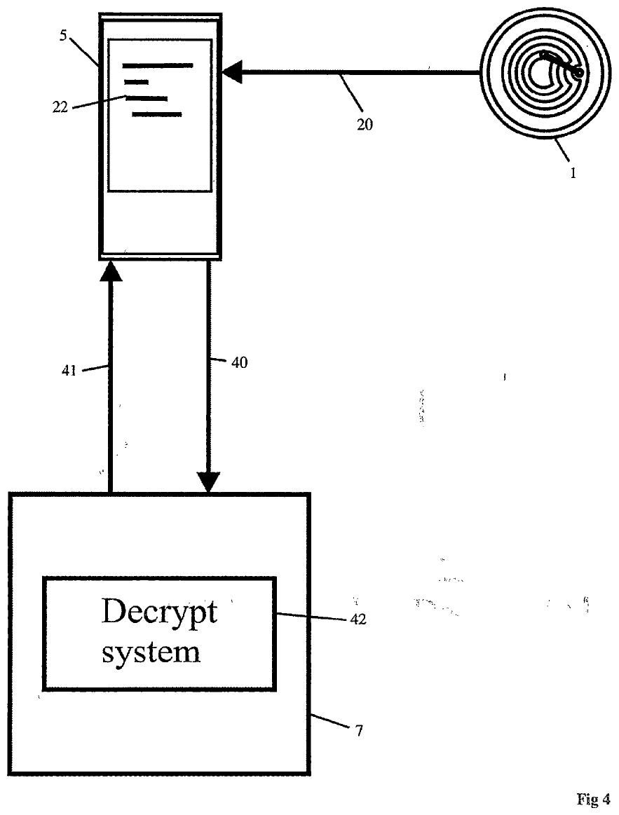

Now referring to FIG. 4, it is illustrated a reader 5 receiving an encrypted message 20 from an NFC tag 1, and transmitting the message to receive a decrypted message from a server. When the NFC tag 1 is scanned by the reader device 5, the tag generates an encrypted message 20 containing the unique identifier and incremented counter value, encrypted using its internal encryption key(s). This encrypted message 20 is transmitted to the reader device 5 such as a smartphone or dedicated scanner.

The reader device 5 then transmits the encrypted message 20 to the server 7 over a network in process 40. The server 7 runs a decryption program 42 to decrypt the message using the appropriate decryption key stored in its database.

The decryption key was previously associated with the tag's unique identifier during programming. By retrieving the key mapped to the scanned tag's identifier, the server can decrypt the message. The decryption may utilize steps such as initializing a cipher algorithm with the decryption key, parsing the encrypted message into blocks, and converting the encrypted blocks into plaintext blocks using the cipher algorithm.

The result of the decryption is a decrypted unique identifier 41 and counter value usable for verification. This decrypted data 41 is transmitted back to the reader device 5. The reader device 5 displays the decrypted message 22 containing the unique identifier and updated counter on its user interface.

The server 7 can then perform authentication by comparing the decrypted unique identifier against valid identifiers in its database. In an exemplary embodiment, if the identifier matches a product, the scan counter is updated to prevent replay attacks. Additionally, the server may, where applicable, analyze owner profiles associated with the product to determine its ownership status.

By only storing the decryption keys on the secure server, the NFC tag data remains protected against potential compromise. This decryption method isolates critical information to the server while still allowing wireless encrypted communication with the tags. It is preferred that after decryption, the server has access to the unique identifiers and scan counts needed to reliably authenticate products and detect anomalous scanning activity.

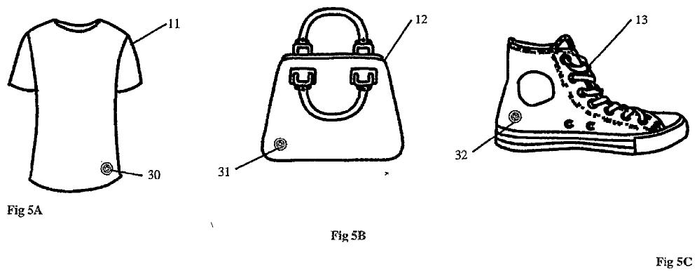

The non-limiting embodiments according to FIGS. 5A, 5B and 5C illustrate a variety of authentic products embedded with encoded NFC tags.

For example, FIG. 5A, a shirt product 11 has an NFC tag 30 integrated into the material. The NFC tag 30 was encoded with a unique identifier and encryption key(s) associated specifically with that shirt product. The unique identifier of tag 30 is matched to the shirt product 11 in a server database. When scanned, the tag 30 generates an encrypted message allowing the shirt 11 to be authenticated.

Similarly, FIG. 5B shows a handbag product 12 with an embedded NFC tag 31 programmed with a unique identifier and encryption key(s) for that specific handbag. The unique identifier of tag 31 associates it with handbag product 12 in the server database. By scanning tag 31, the handbag 12 can be verified as genuine. As an example, for each tag, the database may store the unique identifier (UID) assigned to that tag, as well as a running scan counter tracking the number of times that tag has been scanned.

On the other hand, FIG. 5C displays a shoe product 13 with NFC tag 32 incorporated into the sole. The tag 32 has a unique identifier and encryption key(s) encoding during manufacturing that identify that specific shoe product 13. The identifier for tag 32 maps to shoe product 13 on the server. When tag 32 is scanned, authentication and tracking for the shoe 13 is enabled.

In the embodiments of FIGS. 5A, 5B and 5C every unique product item is associated with a specific NFC tag encoded with information identifying that individual product. By scanning the NFC tag, the product can be verified, authenticated, and tracked through the system. As a specific example, when an encrypted scan message is received from a tag, the server may query the database using the decrypted UID to lookup the scan count value for verification as well as the associated product ID for authentication. This provides robust anti-counterfeiting capabilities at the item-level. A counterfeit product duplicating an authentic tag identifier would easily be detected as a clone. The integration of encrypted NFC technology provides advanced functionality compared to conventional tags easily copied by counterfeiters.

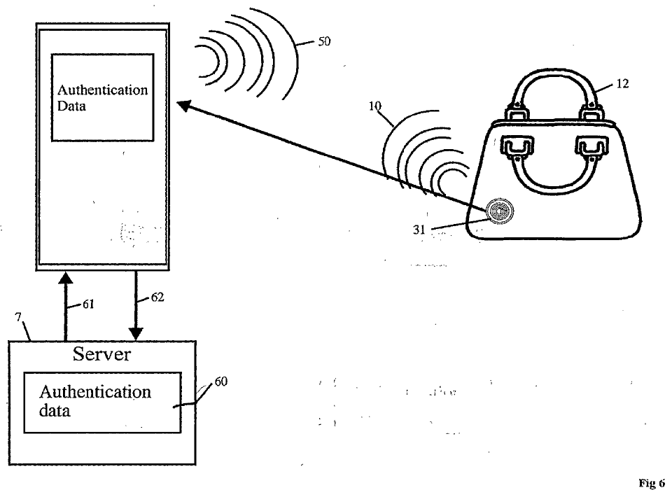

The exemplary illustration of FIG. 6 shows the authentication of the authenticity of a product with an encoded NFC tag. In this example, a handbag product 12 has an embedded NFC tag 31 programmed with a unique identifier and encryption key(s).

When authenticating, a nearby reader device emits an electromagnetic field 50 which powers up the passive NFC tag 31 in the handbag 12. This causes the tag 31 to generate an encrypted message using its' encryption key(s) and containing the unique identifier and incremented scan counter. The NFC tag 31 wirelessly transmits this encrypted message in the form of an electromagnetic signal 10.

The reader receives the signal 10 containing an encrypted message and forwards as an encrypted message request 62 to the verification server 7 over a network. The server 7 executes a decryption program to decrypt the message request 62 using the associated decryption key for the specific NFC tag 31. This decryption key was originally paired to the tag's unique identifier during programming.

By decrypting the message, the server extracts the unique identifier and scan count value. The server checks the identifier against authentication data 60 stored in its database containing valid identifiers mapped to products. If the identifier matches the handbag product 12, the scan counter is verified to prevent replays. This authentication data 60 may also include owner profiles connected to the identifier if registered.

After performing the authentication, the server transmits an authentication response and status 61 back to the reader. This response 61 indicates if the handbag 12 is verified as genuine or potentially fraudulent based on the analysis. The reader displays the authentication message from the server to the user on its interface.

In this manner, the scan of the NFC tag 31 integrated into the physical product 12 triggers an encrypted communication and verification process involving the reader and server to authenticate the item. The authentication data 60 on the server allows reliable confirmation of authenticity for the handbag, providing robust anti-counterfeiting capabilities.

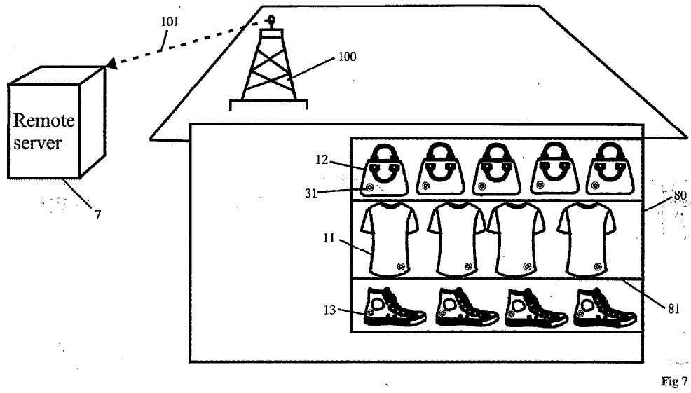

Reference is further made to FIG. 7, which illustrates a monitoring RFID tower 100 provided within the premises of a store 80 for reading tags embedded to products at a store location, and which is connected to a remote authentication server 7. The store 80 has shelves 81 holding various products like shirts 11, handbags 12, and shoes 13 which contain embedded NFC or RFID tags.

The monitoring tower 100 wirelessly scans and collects identifiers from tags within range via communication 101. The tower 100 is connected to the remote verification server 7 over a network. By periodically scanning the store, the tower 100 can detect unique identifiers of products present on the shelves 81.

The store 80 also employs a point of sale system that records sales transactions. When a customer purchases a product, such as the shirt 11, its tag is scanned at checkout and the identifier is transmitted to the server 7, along with customer details. This ties the product to the customer in the server database.

In this way, the server 7 maintains a record of all identifiers associated with the store's inventory through the monitoring tower 100, as well as a sales history from the point of sale system. By comparing the detected in-store identifiers versus sales records, the server can determine products that have been removed from the store without being purchased.

For example, if the handbag 12 identifier is no longer picked up by the tower 100, but there is no sale logged for the handbag 12, the server determines a potential theft. The handbag's 12 identifier is flagged as missing/stolen in the database. If a user later scans the stolen handbag 12 and transmits the identifier, the server will return a warning to the scanning device indicating its status.

As another example of detecting potential theft, the monitoring tower 100 may pick up the shoe product 13's identifier on its periodic scans of the store 80. This indicates the shoe 13 is present on a shelf 81 within the store premises. However, that identifier is then no longer detected by the tower 100 over time.

If there is no point of sale record showing the shoe 13 was purchased, the discrepancy indicates the product may have been removed from the store unlawfully. Even though the shoe 13 itself is no longer physically detected, its encoded unique identifier being absent among the inventory combined with no sale record allows the server 7 to infer a potential theft incident.

The server 7 notes the missing shoe 13 identifier and logs it as a likely stolen product. If a user later attempts to authenticate the shoe 13 by scanning its tag, the server will return a warning message to the user's device stating the product was registered as stolen. This thwarts attempts to verify potentially stolen goods.

By maintaining a real-time inventory via the RFID tower 100 and comparing against sales activity, the server 7 can effectively monitor for anomalies that enable shrinkage detection and stolen product tracking. The unique identifiers allow reconciling physical products with transactions even after removal from a premise. This integration fills a blind spot in typical retail loss prevention.

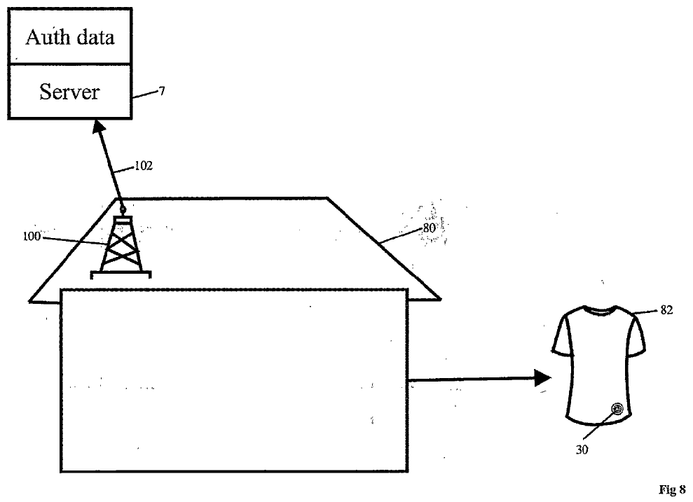

Further, the FIG. 8 is an illustration detection of removal of item from a store by an RFID tower. The store premises 80 has an RFID tower 100 that periodically scans for tags on shelves 81 via communication 101.

In this example, an item 82 was originally located on a store shelf 81 and detected by the RFID tower 100 during its regular scans. The unique identifier of item 82 was included in the periodic status messages 102 sent to the server 7 by the tower 100. However, item 82 has now been removed from the shelf 81 by an unauthorized party. On the next periodic scan by tower 100, the tag in item 82 is no longer detected. Therefore, the next status message 102 to the server 7 does not include the unique identifier for item 82.

By comparing current and prior status messages 102, the server 7 determines the identifier for item 82 is absent in the latest scan but was present earlier. Additionally, there is no point of sale record of item 82 being purchased.

Due to the discrepancy of item 82 no longer being detected but not recorded as sold, the server 7 infers that item 82 has been unlawfully removed. The server 7 marks item 82 as a likely stolen product. Any future authentication attempts via the tag in item 82 will return a warning about its status. This demonstrates how constant RFID monitoring combined with sales records can identify products leaving a premise illegally based on missing identifiers. As such, the system provides automated shrinkage detection and stolen item tracking.

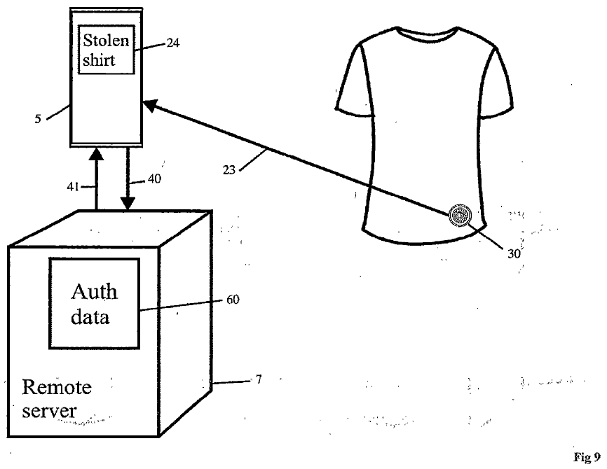

The FIG. 9 illustrates an example verification of a stolen product with an encoded NFC tag according to an embodiment. In this example, a shirt product contains an embedded NFC tag 30 which has been registered as stolen in the server database 7. When a reader device 5 scans the tag 30, the tag generates an encrypted message 23 containing its unique identifier and incremented scan counter, encrypted using the tag's internal encryption key(s). This encrypted message 23 is transmitted to the reader 5.

Subsequently, the reader 5 sends the encrypted message in request 40 to the verification server 7 via the network. The server 7 runs a decryption program to decrypt the message using the appropriate decryption key paired to the NFC tag 30 when it was programmed. The decryption provides the unique identifier which the server checks against authentication data 60 in its database. This authentication data 60 may contain entries marking certain products like the shirt 11 as stolen based on prior detection. The server 7 determines the shirt identifier matches a stolen item report.

The server 7 transmits a verification response 41 back to the reader 5 indicating the stolen status. The decrypted data causes the reader 5 to display a warning banner on its interface notifying the user the shirt 11 has been registered as a stolen item. This provides an additional layer of security and tracking. Even if a stolen product's NFC tag is not removed or destroyed, the system integration allows flagged items to be detected when scanned. The true status warnings prevent stolen goods from being verified as legitimate.

In an exemplary application law enforcement attempting to identify recovered stolen merchandise could also utilize the system. By scanning items, officers can quickly check against the database to determine if goods have been reported missing or stolen based on the encrypted tag communications and server verification.

In one non-limiting aspect, a programming device utilizes salting techniques to generate derived unique encryption and decryption keys for each NFC tag. A random arbitrary value, such as the tags unique identifier (UID), is combined with a base encryption key provided by the server using a cryptographic hash function.

The described embodiments for product authentication using encrypted NFC tags could be implemented fully on the scanning device itself or using a client-server architecture.

In a single device approach, the NFC tag scanning, encryption key handling, message encryption/decryption, and authentication could potentially occur entirely locally on the user's scanner without external communication.

Alternatively, a client-server implementation could distribute processing between scanner devices and the verification server. The scanner may read tags, display interfaces, and transmit data, while the server performs decryption, database comparisons, stolen product checks, and returns authentication results. This leverages server computing resources.

The optimal implementation may depend on factors like processing needs, security priorities, network availability, and speed requirements. User-facing scanning operations may be device-based, while decryption and database functions can utilize the server. But the core invention could be realized either locally or distributed.

The present system may be embodied as a full device-level application, distributed client-server method, or computer program product storing instructions for any integration level. Computer program embodiments may comprise computer readable media storing code to direct processors to enact claimed aspects.

The described operations could be implemented as executable code, hardware logic, or combinations directing an apparatus to function per the invention. The code may be provided to a general purpose or special purpose processor to generate means for implementing the specified capabilities.

Various modifications and combinations of the embodiments described are possible within the scope of the claimed invention. Thus, the applicant intends to cover reasonable alterations and equivalents aligned with the inventive concepts.

Use of singular or plural terms is meant to encompass all options, unless explicitly limited. The term “or” in particular implies “and/or” except where otherwise indicated.

### INDUSTRIAL APPLICATION

The present invention has industrial applicability for companies producing valuable branded merchandise vulnerable to counterfeiting and theft, such as luxury apparel, handbags, shoes, watches, jewelry, electronics, and pharmaceuticals. The encrypted NFC tags provide robust anti-counterfeiting abilities while integration with ownership tracking and point of sale systems enables advanced loss prevention features. Retail stores, transportation and distribution networks, and law enforcement agencies can implement the invention to combat black market trade and sale of stolen goods. Additionally, the technology can be applied to authenticating components and preventing theft of critical parts in sectors such as aerospace, automotive, and medical devices.

What is claimed is:

1. A system for product authentication comprising:
a scanning device configured to scan an radio frequency (RF) device to receive from said device an encrypted message generated using the unique identifier, counter value, and encryption key, and transmit to a verification server the encrypted message to receive from the verification server an authenticity and/or ownership status of a product embedded with the RF device, wherein:
an RF devices embedded in a product is encoded with a unique identifier, counter algorithm, and encryption key; and
a verification server is provided thereto being configured to:
generate and/or store encryption keys and associated decryption keys;
maintain a database associating unique identifiers with products;
receive encrypted messages from the scanning device and decrypt using the decryption keys; and
transmit authenticity and/or ownership status data of scanned products based on the decrypted messages.

2. The system of claim 1, wherein the verification server is further configured to:
maintain a database of unique identifiers corresponding to products located in a store;
determine products sold by receiving data from a point of sale system;
identify products as stolen if the unique identifier is not detected within the store and no sale is recorded; and
return a stolen product warning if an encrypted message received when a product identified stolen is scanned by a scanning device.

3. The system of claim 1, wherein the verification server is further configured to:
maintain a database associating unique identifiers with owner profiles;
receive and store an association between a unique identifier and an owner profile when a product is scanned and registered; and
transfer the association to a new owner profile upon receiving an ownership transfer request.

4. The system of claim 1, wherein the scanning device is a mobile device executing an authentication application for interfacing with the RF devices and verification server.

5. The system of claim 1, wherein the verification server is further configured to maintain a database of authorized distributors and confirm distributor authenticity based on the decrypted messages.

6. The system of claim 1, wherein the encryption keys are generated and embedded into the RF devices by an encoding device during manufacturing or packaging of products.

7. A computer program product comprising a non-transitory computer-readable medium storing instructions that, when executed by a processor, cause the processor to perform a method for product authentication comprising:
encoding a plurality of RF devices, wherein each RF device is encoded with a unique identifier, counter algorithm, and encryption key;
generating an encrypted message when an RF device is scanned by utilizing the unique identifier, counter value, and encryption key encoded on the tag;
decrypting received encrypted messages utilizing stored decryption keys; and
determining authenticity or ownership status of products associated with scanned RF devices based on the decrypted messages.

8. The computer program product of claim 7, wherein the instructions further cause storing associations between unique identifiers and owner profiles, and transferring ownership when requested.

9. The computer program product of claim 7, wherein the instructions further cause identifying products as stolen by comparing detected unique identifiers at a location to point of sale records.

10. The computer program product of claim 7, wherein the instructions further cause interfacing with RF devices using a mobile authentication application.

11. The computer program product of claim 7, wherein the instructions further cause confirming distributor authenticity based on the decrypted messages.

12. The computer program product of claim 7, wherein the instructions further cause generating and embedding encryption keys into the RF devices during manufacturing or packaging.

13. The computer program product of claim 7, wherein the instructions utilize a verification server for storing decryption keys and product associations for the decryption and authentication.

14. A computer-implemented authentication method comprising:
receiving, at a scanning device, an encrypted message generated by scanning an RF device encoded with a unique identifier, counter, and encryption key, wherein the encrypted message is generated at the RF device utilizing the unique identifier, counter value, and encryption key;
transmitting the encrypted message from the scanning device to a verification server;
receiving an authentication result at the scanning device from the verification server, wherein the verification server is configured to:
maintain a database associating unique identifiers with products;
store encryption keys and associated decryption keys;
decrypt the encrypted message using a corresponding decryption key; and
determine authenticity or ownership of the product based on the decrypted message.

15. The method of claim 14, wherein the RF device generates the encrypted message by:
incrementing the counter value;
retrieving the unique identifier and encryption key; and
generating the encrypted message using the unique identifier, counter value, and encryption key.

16. The method of claim 14, wherein the verification server determines authenticity and ownership status by:
decrypting the encrypted message using the stored decryption key;
comparing the unique identifier to identifiers associated with products in its database; and
analyzing owner profiles associated with the unique identifier.

17. The method of claim 14, wherein the scanning device executes an authentication application to interface with the RF devices and verification server.

18. The method of claim 14, further comprising receiving an ownership transfer request at the scanning device and transmitting to the verification server to update associated owner profiles.

19. The method of claim 14, further comprising displaying product information associated with the unique identifier when an authenticity confirmation is received from the verification server.
